(19) United States
(12) Patent Application Publication
(10) Pub. No.: US 2017/0214973 A1
(43) Pub. Date: Jul. 27, 2017

(54) INTERACTIVE DISPLAY TELECOMMUNICATION METHOD AND SYSTEM

(71) Applicant: I-SPY DIGITAL LIMITED, Newcatle-upon-Tyne, North Tyneside (GB)

(72) Inventors: Paul SLAUGHTER, Newcatle-upon-Tyne, North Tyneside (GB); Wayne MUTER, Newcatle-upon-Tyne, North Tyneside (GB)

(21) Appl. No.: 15/320,645

(22) PCT Filed: May 20, 2015
(86) PCT No.: PCT/GB2015/000152

§ 371 Date: Dec. 20, 2016

(30) Foreign Application Priority Data
May 28, 2014 (GB) 1409406.4

(51) Int. Cl. H04N 21/4788; H04N 21/4227; H04N 21/431; H04L 29/12; H04N 21/488

(52) U.S. Cl. CPC H04N 21/4788; H04L 61/6022; H04N 21/4882; H04N 21/4316; H04N 21/4227

(57) ABSTRACT

An interactive display communication device, and communication method and system using the device, are provided. The device comprises audio and video data input and output means and networking means, all operably interfaced with data processing means. The data processing means is configured to composite input video data with a user interface of a browser application having a client messaging application extension, and to output the composited video data including any message composed at a remote terminal and received from a remote server. The device is provided with remote user input means for interacting with the device in real time. The remote user input means is configured by the data processing means for interaction with the client messaging application according to at least one configuration parameter encoded in each message.

### FIELD OF THE INVENTION

The present invention relates to a distributed communication method and system configuring legacy audio-video equipment for real-time bilateral messaging.

### BACKGROUND OF THE INVENTION

Further to the relatively recent development of cost-effective mobile telecommunications networks for voice and alphanumerical messaging, as well as wide area network messaging such as instant messaging and electronic mail, and their consequent mass adoption and use, there is a growing assumption that just about every individual is equipped with relevant data processing and communication equipment for partaking in such communication techniques. Such is the ubiquitous character of always-on communications between individuals nowadays that, for example, the respective email address and/or mobile telephone number of individuals are now commonly required as part of such formal administrative procedures as applying for a passport or registering with a government service.

The acquisition and operation of relevant equipment, typically personal computers, mobile telephone handsets and other portable computing devices, requires financial resources, contextual knowledge and operational skills which many people lack, for a wide variety of wealth, health and/or accessibility-related reasons. For instance, elderly persons are notoriously adverse to technological change, an issue compounded by the ever-increasing pace of technical development, and correspondingly-premature technical obsolescence, of communication equipment and formats.

It is thus still difficult for a person to avail of modern telecommunication technologies for communicating information, urgently or otherwise, to an interlocutor who does not own and/or does not know how to operate a modern telecommunication device such as a mobile phone or a computer. Communications would thus still have to take place in a differed manner, either during a next personal visit to the intended recipient, or via a third party suitably equipped with relevant telecommunication means and in the care of whom the information may be left for passing on to the intended recipient, for instance a nurse or carer where the intended recipient is an elderly or impaired person.

Prior art communication solutions may be considered for attempting to solve the above problem, including for instance a paging device connected to a mobile telecommunication network, however such solutions are both costly and passive and typically do not include means for the recipient to actively acknowledge receipt of the message, lest either the device is suitably configured and with the use of which the recipient must therefore again become familiar, or the recipient inconveniently requires the use of a different device, for instance a conventional domestic telephone, for providing the acknowledgement.

An alternative telecommunication method is therefore preferably required, and a system embodying this method, for mitigating at least the problems described above.

### SUMMARY OF THE INVENTION

The inventors have realized that television sets, as information displaying devices, are at least as ubiquitous as mobile communication devices and computers, and which most people both have the personal use of, and know how to operate with simple control commands input into a remote control device, relatively independently of wealth, health and/or accessibility-related reasons. Accordingly, the inventors have created an alternative telecommunication method and a corresponding system, which rely upon the presence of, and associated familiarity of use with, legacy display equipment.

The invention provides interactive telecommunication techniques for users unskilled in, and/or not equipped with, ubiquitous telecommunication methods involving mobile telephones and computers, wherein messages personalised by respective senders are communicated to display equipment, typically a television set, with the operation of which such users are familiar and wherein such messages automatically overlay the displayed broadcast or local source video signal when received.

Accordingly, in a first aspect of the invention, a method of communicating with an interactive display communication device connected to a network, comprising the steps of encoding at least one input configuration parameter in a message remotely from the device and communicating message data to the device, processing a client messaging application at the device for displaying received messages in a user interface, processing output video data at the device as a plurality of composited display layers including at least top and bottom layers, assigning video data input to the device to the bottom layer, assigning the user interface to the top layer; and, when message data is received at the device, processing the message data with the client messaging application, configuring a remote user input means associated with the device for interaction with the client messaging application according to the or each input configuration parameter, and outputting the message to the user interface.

This method advantageously allows recipients to receive messages substantially in real-time, without any other further operational skills than those previously acquired with the operation of the display device, typically a television set.

In an embodiment of the method, the client messaging application comprises a browser configured with a client messaging extension, wherein the step of assigning a user interface further comprises assigning a transparent user interface of the browser to the top layer. In this embodiment, the broadcast or local source video signal is effectively displayed in real-time and continuously overlaid by the transparent user interface of the browser, which is itself updated with received messages likewise in real-time. Accordingly, in a variant of this embodiment, the step of outputting further comprises substituting a portion of the transparent user interface with the message.

In an embodiment of the method, the step of encoding further comprises encoding a plurality of input configuration parameters in the message, wherein each input configuration parameter is respectively assigned to an input command of the remote user input means. When processed, the encoded one or more input configuration parameters in the message configures the remote user input means, for instance a television set remote control, for interaction with the device according to the context of the message, in that at least an acknowledgement (in the case of a single input parameter) or alternative replies (in the case of several single input parameters) to a message are associated to respective input(s), typically buttons, of the remote user input means.

Accordingly, an embodiment of the method may comprise the further steps of reading at least one input command from the remote user input means and matching the or each input command to a respective input configuration parameter at the device.

Accordingly still, a further embodiment of the method may comprise the further steps of processing reply message data according to the or each matched input configuration parameter and communicating the reply message data to a remote recipient.

In an embodiment of the method, the steps of encoding and communicating are performed at a remote server over the network. The server may be operated by a messaging service provider and adapted to coordinate the devices temporally and operationally, in addition to grouping devices thematically and/or geographically.

In a variant of this embodiment, the method may comprise the further step of inputting message data and selecting the, or each, input configuration parameter with a networked terminal remote from the server and the interactive display communication device. This alternative advantageously allows a message sender to author and format the message and its one or more alternative replies with the sender's own equipment, for instance a personal computer or a mobile telephone handset, with the convenience of that sender's own time, location and circumstances.

In a further variant of this embodiment, the method may comprise the further step of associating media data with the input message data, wherein the media data is at least one selected from the group comprising audio data, video data, image data and audio-video data. This embodiment advantageously allows a sender to improve the context and increase the information content of the message, for facilitating the comprehension of the message by the recipient.

In a variant of this latest embodiment, the step of associating may further comprise recording the media data locally with the networked terminal remote from the server and the interactive display communication device. This embodiment advantageously allows a sender to capture local data remotely from both the interactive display communication device and the server, and to combine the increased convenience for the sender to author and format the message in their own time, location and circumstances with improving the context of the message.

In another aspect of the invention, a display communication system is also provided, which comprises at least one interactive display communication device connected to a network and adapted to process a client messaging application for displaying one or more received message in a user interface and to composite the user interface on ar input video stream, wherein the device is provided with remote user input means for interacting with the device in real time, and a first remote data processing terminal connected to the network, wherein the first remote terminal processes a server messaging application communicating message data across the network to the client messaging application processed by the or each interactive display communication device, and wherein the remote user input means is configurable by the server messaging application for interaction with the client messaging application according to at least one configuration parameter encoded in each message.

In compliance with proposed embodiments of the method of the invention, in an embodiment of the system, the client messaging application may comprise a browser configured with a client messaging extension, and wherein the user interface is a transparent user interface of the browser.

In compliance with proposed embodiments of the method of the invention, in an embodiment of the system, the system may further comprise at least a second remote data processing terminal connected to the network, adapted to input message data and to select the or each input configuration parameter remotely from the first remote data processing terminal and from the or each interactive display communication device. In a variant of this embodiment, the or each second remote data processing terminal is preferably selected from the group comprising mobile telephone handsets, mobile computers, tablet computers, desktop computers.

In compliance with proposed embodiments of the method of the invention, in an embodiment of the system, the first remote data processing terminal may be further configured to communicate a message to a plurality of interactive display communication devices grouped according to at least one predetermined criteria. Such predetermined criteria may be selected from the group comprising at least device geographical location, user service provider, user care provider, thematic grouping. A practical example of geographical grouping may be all the individual interactive display communication devices operated by residents of a care home. Practical examples of thematic grouping, which are not incompatible with the above geographical example and may co-exist therewith as distinct and/or additional criteria defining different and potentially overlapping groups, may be all the individual interactive display communication devices operated by users registered with a same medical practice, and/or all the individual interactive display communication devices operated by users of a same family.

In an embodiment of the system, the or each interactive display communication device is preferably uniquely identified to the first remote data processing terminal by its Media Access Control (‘MAC’) address. Advantageously, as an industry standard network identifier, this choice simplifies implementation of the system, guarantees the unique identity of each interactive display communication device in the system, and facilitates scalability of the system for accommodating ever more interactive display communication devices.

In an embodiment of the system, the or each interactive display communication device is an audio-video pass-through device having connectivity for connection to legacy audio-video equipment. Advantageously, this variant permits any legacy display equipment, including decades-old CRT television sets, to be retrofitted into the telecommunication of the present invention.

According to yet another aspect of the present invention, there is also provided an interactive display communication device comprising audio and video data input means, audio and video data output means and networking means, all operably interfaced with data processing means, the data processing means being configured to process a client messaging application for displaying each received message in a user interface, process output video data as a plurality of composited display layers including at least top and bottom layers, assign input video data to the bottom layer and assign the user interface to the top layer; wherein the device is provided with remote user input means for interacting with the device in real time and, when message data is received via the networking means, the data processing means is further configured to process the message data with the client messaging application, configure the remote user input means for interaction with the client messaging application according to at least one input configuration parameter encoded in the message data, and output the message to the user interface.

In compliance with proposed embodiments of the method of the invention, in an embodiment of the device, the client messaging application comprises a browser configured with a client messaging extension, and wherein the user interface of the browser is substantially transparent.

In an embodiment of the device, the at least one configuration parameter preferably binds at least one input command of the remote user input means to at least a message acknowledgement function call of the client messaging application. Alternatively, a plurality of configuration parameters may bind respective keys or buttons of the remote user input means to respective function calls of the client messaging application selected from the group comprising navigation and selection inputs.

In an embodiment of the device, the audio and video data input means is at least one selected from the group comprising analogue signal sockets such as an RF signal input socket, a set of analogue sockets including a CVBS or S-VHS or D-SUB socket, a SCART socket, and digital signal sockets such as a HDMI socket, a DVI socket.

In an embodiment of the device, the audio and video data output means is at least one selected from the group comprising analogue signal sockets such as an RF signal output socket, a set of analogue sockets including a CVBS or S-VHS or D-SUB socket, a SCART socket, and digital signal sockets such as a HDMI socket, a DVI socket. A variant of this embodiment may usefully comprise digital content protection means operably interfaced with the digital signal sockets, for instance a DHCP module in the case of HDMI or DVI connectivity, to ensure that display of a copy-protected source signal, for instance from a commercial BluRay disc played by a BluRay player, is not impeded by the device.

In an embodiment of the device, the RF signal may usefully be selected from the group comprising analogue tuners complying with any or all of the Phase Alternating Line (PAL), the National Television System Committee (NTSC) or the Sequential Color with Memory (SECAM) standards, digital tuners complying with the Digital Video Broadcasting (DVB) or Advanced Television Systems Committee (ATSC) standards, in order to maintain interoperability with legacy display equipment.

In an embodiment of the device, the networking means is preferably at least one selected from the group comprising a registered jack (RJ) wired network interface, a wireless Network Interface Card (WNIC), a Universal Serial Bus interface (USB), a Bluetooth network interface. Preferably still, an embodiment of the device may include at least one of each of the above-listed networking connectivity formats, in order to improve the compatibility prospects of the device with a user's legacy networking environment.

According to further aspects of the present invention, there are also provided a set top box configured to perform the method substantially as described herein, and a server configured to perform that method in combination with at least one interactive display communication device substantially as described herein.

For any of the above embodiments and further variants, the or each interactive display communication device preferably comprises one selected from the group comprising a television set, a set top box, a physical media player, a digital media player, a streaming media player, a videogames console. It is considered that the system may comprise any number of such varied types of devices, all configured in substantially similar manner to implement the simple message-based telecommunication method described herein.

For any of the above embodiments and further variants still, the remote user input means preferably comprises at least one selected from the group comprising an IR remote control device, an RF remote control device, a mobile telephone handset. All such remote control devices, including a mobile telephone handset suitably configured with a third party remote control-emulating application, are expected to provide the relevant basic interactive functionality corresponding to skills associated with the operation of a display device.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a network environment comprising a communication network and a plurality of data processing devices, including a mobile terminal, a server and a messaging device according to an embodiment of the invention.

FIG. 2 is a logical diagram of a typical hardware architecture of the mobile data processing and communication terminal shown in FIG. 1, including memory means.

FIG. 3 is a logical diagram of a typical hardware architecture of the server shown in FIG. 1, including memory means.

FIG. 4 illustrates an embodiment of an interactive messaging device shown in FIG. 1, including audio-video input and output means.

FIG. 5 illustrates is a logical diagram of a hardware architecture of the messaging device embodiment shown in FIG. 4, including memory means.

FIG. 6 is a functional diagram of the iterative data processing steps of an embodiment of the method of the invention performed in the environment of FIG. 1.

FIG. 7 details data processing steps performed by the interactive messaging device of FIGS. 1, 4 and 5 in the context of the method of FIG. 6.

FIG. 8 further details certain data processing steps of FIG. 7.

FIG. 9 is a logical diagram of the contents of the memory means of the interactive device shown in FIGS. 1, 4 and 5, when performing the method of FIGS. 7 and 8, including a firmware application

FIG. 10 illustrates the data flow between distinct data structures shown in FIG. 9, including distinct application layers of the firmware of FIG. 9, at runtime.

FIG. 11 details data processing steps performed by the mobile data processing and communication terminal of FIGS. 1 and 2 in the context of the method of FIG. 6.

FIG. 12 is a logical diagram of the contents of the memory means of the mobile terminal shown in FIGS. 1 and 2, when performing the steps of FIG. 11.

FIG. 13 illustrates a message authored according to the steps of FIG. 11 and displayed by an interactive messaging device when received, including a plurality of user input choices according to a corresponding plurality of user input parameters encoded in the received message.

FIG. 14 details data processing steps performed by the server of FIGS. 1 and 3 in the context of the method of FIG. 6.

FIG. 15 is a logical diagram of the contents of the memory means of the server shown in FIGS. 1 and 3, when performing the steps of FIG. 14.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

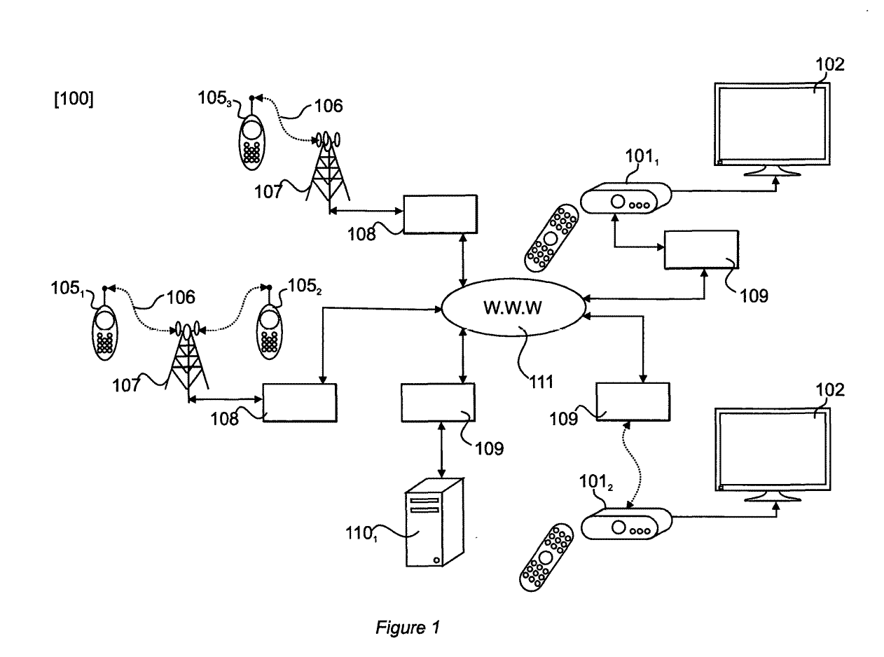

With reference to FIG. 1 firstly, an example embodiment of a telecommunication system 100 according to the invention is shown within a networked environment. The networked environment includes a plurality of data processing devices, consisting of at least one display communication device 101 connected with a respective conventional display device 102 such as a television set 102, at least one mobile data processing terminal 105, and at least one further data processing terminal 110 configured as a server. The or each mobile terminal 105_{N} and the at least one server 110 are capable of respective data communication with each another, and the or each display communication device 101_{N} and the at least one server 110 are also capable of respective data communication with each another, across a single or hybrid network including a Wide Area Network (‘WAN’) 111 such as the World Wide Web or Internet.

In the foregoing, the description will focus upon the respective configurations and interaction of three distinct types of terminals by way of non-limitative example, for the purpose of not obscuring the present description unnecessarily, wherein at least one mobile data communication device 105 is operated by a user desirous of communicating a message to a remote user having the use of a personal television set 102 to which a display communication device 101 is connected, and wherein the messaging is coordinated by a remote server 110. It will be readily understood by the skilled person from the foregoing, that the techniques and principles described herein may be both easily and significantly scaled up to a non-trivial number of inter-connected terminals, without the exercise of any inventive step.

In the example, the or each mobile data communication device 105_{N} is a mobile telephone handset 105 having wireless telecommunication emitting and receiving functionality over a cellular telephone network configured according to the Global System for Mobile Communication (‘GSM’), General Packet Radio Service (‘GPRS’), International Mobile Telecommunications-2000 (IMT-2000, ‘W-CDMA’ or ‘3G’), International Mobile Telecommunications-Advanced, (ITU-R-compliant and known as ‘4G’) network industry standards, and wherein telecommunication is performed as voice, alphanumeric or audio-video data using the Short Message Service (‘SMS’) protocol, the Wireless Application protocol (‘WAP’) the Hypertext Transfer Protocol (‘HTTP’) or the Secure Hypertext Transfer Protocol (‘HTTPS’).

The or each mobile telephone handset 105_{N} receives or emits voice, text, audio and/or image data encoded as a digital signal over a wireless data transmission 106, wherein the signal is relayed respectively to or from the handset by the geographically-closest communication link relay 107 of a plurality thereof. The plurality of communication link relays 107 allows digital signals to be routed between each handset 105 and their destination by means of a remote gateway 108 via a MSC or base station 109. Gateway 108 is for instance a communication network switch, which couples digital signal traffic between wireless telecommunication networks, such as the cellular network within which wireless data transmissions 106 take place, and the Wide Area Network 111. The gateway 108 further provides protocol conversion if required, for instance whether a handset 105 uses the WAP or HTTPS protocol to communicate data.

Alternatively, or additionally, the or each mobile data communication device 105_{N} may have wired and/or wireless telecommunication emitting and receiving functionality over, respectively, a wired Local Area Network (‘LAN’) and/or a wireless local area network (‘WLAN’) conforming to the 802.11 standard (‘Wi-Fi’). In the LAN or WLAN, telecommunication is likewise performed as voice, alphanumeric and/or audio-video data using the Internet Protocol (IP), Voice data over IP (‘VoIP’) protocol, Hypertext Transfer Protocol (‘HTTP’) or Secure Hypertext Transfer Protocol (‘HTTPS’), the signal being relayed respectively to or from the mobile data communication device 105 by a wired (LAN) or wireless (WLAN) router 109 interfacing the mobile data communication device 105 to the WAN communication network 111. A mobile telephone handset 105 may have wireless telecommunication emitting and receiving functionality over the WLAN in addition to GSM, GPRS, W-CDMA and/or 3G, ITU-R/4G.

A typical handset 105_{N} for use with the system according to the invention is preferably that commonly referred to as a ‘smartphone’ and may for instance be an iPhone™ handset manufactured by the Apple Corporation or an equivalent handset configured with the Android™ operating system provided by Google, Inc. Generally, the mobile terminal 105 may be any portable data processing device having at least wireless communication means and audio recording and storage means. It will therefore be readily understood by the skilled person from the present disclosure, that one or more of the mobile data communication devices 105 may instead be a portable computer commonly referred to as a ‘laptop’ or ‘netbook’, a tablet computer such as an Apple™ iPad™ or a Samsung™ Galaxy™, and the like.

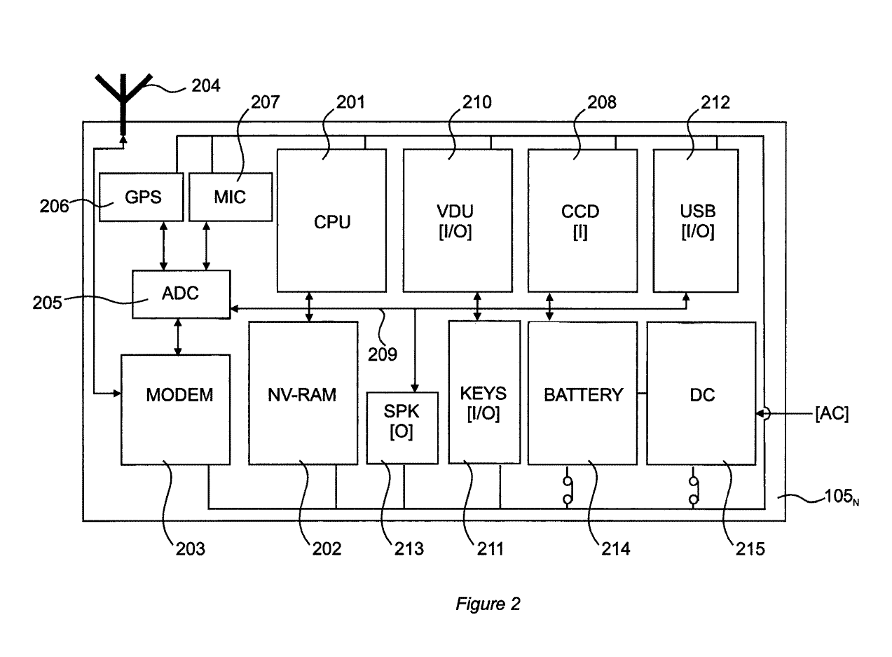

Accordingly, a typical hardware architecture of a mobile telephone handset 105_{N} is shown in FIG. 2 in further detail, by way of non-limitative example. The handset 105 firstly includes a data processing unit 201, for instance a general-purpose microprocessor (‘CPU’), acting as the main controller of the handset 105 and which is coupled with memory means 202, comprising non-volatile random-access memory (‘NVRAM’).

The mobile telephone handset 105 further includes a modem 203 to implement the wireless communication functionality, as the modem provides the hardware interface to external communication systems, such as the GSM or GPRS cellular telephone network 107, 108 shown in FIG. 1. An aerial 204 coupled with the modem 203 facilitates the reception of wireless signals from nearby communication link relays 107. The modem 203 is interfaced with or includes an analogue-to-digital converter 205 (‘ADC’) for demodulating wavelength wireless signals into digital data, and reciprocally for outgoing data.

The handset 105 further includes self-locating means in the form of a GPS receiver 206, wherein the ADC 205 receives analogue positional and time data from orbiting satellites (not shown), which the data processing unit 201 or a dedicated data processing unit processes into digital positional and time data.

The handset 105 further includes a sound transducer 207, for converting ambient sound waves, such as the user's voice into an analogue signal, which the ADC 205 receives for the data processing unit 201 or a dedicated data processing unit to process into digital first audio data.

The handset 105 may optionally further include imaging means 208 in the form of an electronic image sensor, for capturing image data which the data processing unit 201 or a dedicated data processing unit processes into digital image data.

The CPU 201, NVRAM 202, modem 203, GPS receiver 206, microphone 207 and optional digital camera 208 are connected by a data input/output bus 209, over which they communicate and to which further components of the handset 105 are similarly connected, in order to provide wireless communication functionality and receive user interrupts, inputs and configuration data.

Alphanumerical and/or image data processed by CPU 201 is output to a video display unit 210 (‘VDU’), from which user interrupts may also be received if it is a touch screen display. Further user interrupts may also be received from a keypad 211 of the handset, or from an external human interface device (‘HiD’) connected to the handset via a Universal Serial Bus (‘USB’) interface 212. The USB interface advantageously also allows the CPU 201 to read data from and/or write data to an external or removable storage device. Audio data processed by CPU 201 is output to a speaker unit 213.

Power is provided to the handset 105 by an internal module battery 214, which an electrical converter 215 charges from a mains power supply as and when required.

The system 100 next includes at least one data processing terminal 110_{N}, in the example a server terminal 110, which emits and receives voice, alphanumeric and/or audio-video data encoded as a digital signal using the Internet Protocol (IP), Voice data over IP (‘VoIP’) protocol, Hypertext Transfer Protocol (‘HTTP’) or Secure Hypertext Transfer Protocol (‘HTTPS’), over a wired data transmission conforming to the IEEE 802.3 (‘Gigabit Ethernet’) standard, wherein the signal is relayed again respectively to or from the computing device by a wired router 109 interfacing the computing device 110 to the WAN communication network 111. Generally, the or each data processing terminal 110_{N} may be any portable or desktop data processing device having at least networking means apt to establish a data communication with the or each mobile data communication device 105_{N} and the or each interactive display communication device 101 as described hereafter.

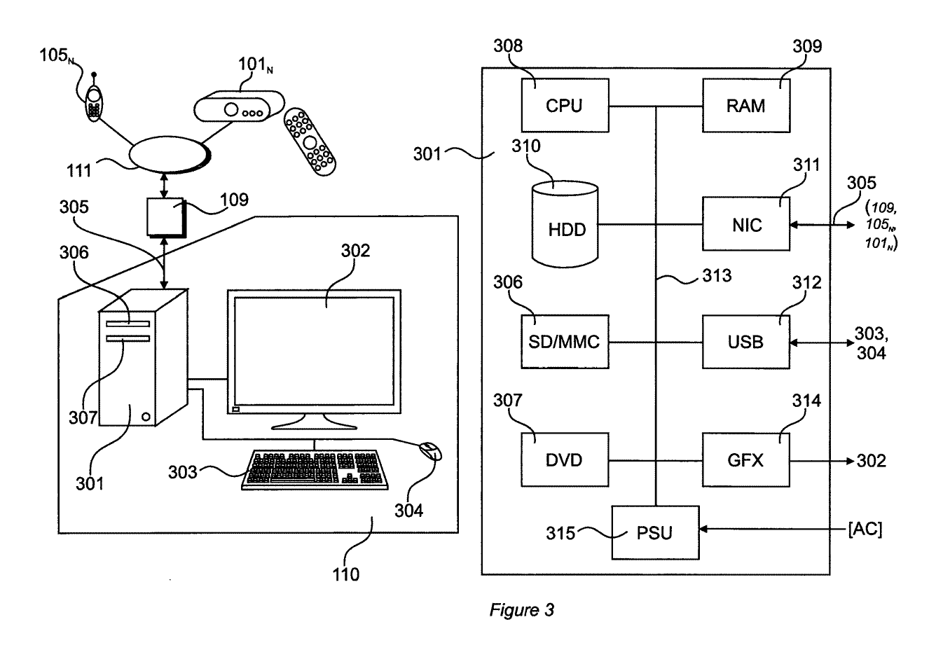

A typical hardware architecture of a data processing terminal 110_{N} is shown in FIG. 3 in further detail, by way of non-limitative example. The data processing device 110 is a computer configured with a data processing unit 301, data outputting means such as video display unit (VDU) 302, data inputting means such as HiD devices, commonly a keyboard 303 and a pointing device (mouse) 304, as well as the VDU 302 itself if it is a touch screen display, and data inputting/outputting means such as the wired network connection 305 to the communication network 111 via the router 109, a magnetic data-carrying medium reader/writer 306 and an optical data-carrying medium reader/writer 307.

Within data processing unit 301, a central processing unit (CPU) 308 provides task co-ordination and data processing functionality. Sets of instructions and data for the CPU 308 are stored in memory means 309 and a hard disk storage unit 310 facilitates non-volatile storage of the instructions and the data. A wireless network interface card (NIC) 311 provides the interface to the network connection 305. A universal serial bus (USB) input/output interface 312 facilitates connection to the keyboard and pointing devices 303, 304.

All of the above components are connected to a data input/output bus 313, to which the magnetic data-carrying medium reader/writer 306 and optical data-carrying medium reader/writer 307 are also connected. A video adapter 314 receives CPU instructions over the bus 313 for outputting processed data to VDU 302. All the components of data processing unit 301 are powered by a power supply unit 315, which receives electrical power from a local mains power source and transforms same according to component ratings and requirements.

The system 100 next includes at least one interactive display communication device 101 connected to a television set 102, which emits and receives voice, alphanumeric and/or audio-video data encoded as a digital signal using the Internet Protocol (IP), Hypertext Transfer Protocol (‘HTTP’) or Secure Hypertext Transfer Protocol (‘HTTPS’), over a wired data transmission conforming to the IEEE 802.3 (‘Gigabit Ethernet’) standard and/or a wireless local area network (‘WLAN’) conforming to the 802.11 standard (‘Wi-Fi’), wherein the signal is relayed again respectively to or from the device 101 by a wired and/or wireless router 109 interfacing the device 101 to the WAN communication network 111.

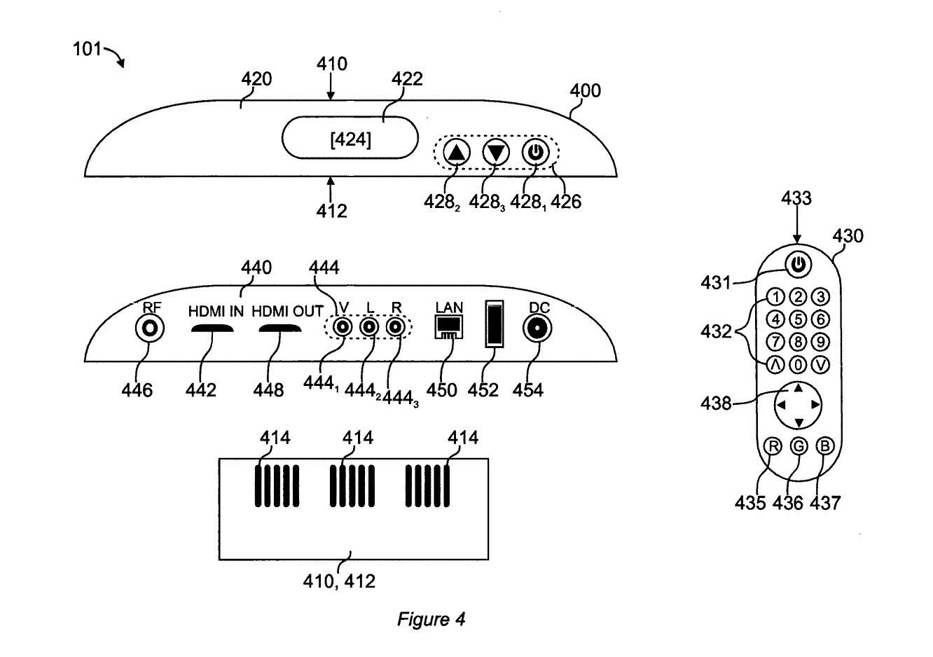

With reference to FIG. 4, an embodiment of the display communication device 101 is shown in FIG. 4 in further detail, by way of non-limitative example. The device comprises a generally oblong enclosure 400 having curved lateral walls flaring from a top surface 410 towards a bottom surface 412, wherein each of the top and bottom surfaces comprises a plurality of through-apertures 414 for facilitating circulation of ambient air in and out of the device 101.

A front side 420 of the device, substantially perpendicular to the top and bottom sides 410, 412 comprises a through-vision panel 422 behind which an infrared input interface 424 is located for reading user commands input via a remote handset 430 provided with the device 101 and described in further detail hereafter. The front side 420 further comprises a physical user interface 426 located adjacent the through-vision panel 422, having a plurality of user-activated pushbuttons 428_{N}, including at least an on/off switch 428₁ and two navigation input buttons 428₂, 428₃ provided as a failsafe for inputting user menu navigation commands, in case any of the infrared input interface 424, the remote handset 430 or the input processing functionality associated with same should fail.

A rear side 440 of the device, substantially perpendicular to the top and bottom sides 410, 412 comprises first, second and third audio-video input interfaces 442, 444, 446. The first audio-video input interface 442 is a digital interface conforming to the EIA/CEA-861 standards, which is intended for connection with any legacy device outputting a digital audio-video signal, typically a Blu-ray™ Disc player and the like, and thus comprises a single High-bandwidth Digital Content Protection (HDCP)-enabled High Definition Multimedia Interface (‘HDMI’) socket.

The second audio-video input interface 444 is an analogue interface conforming to the coaxial radiofrequency standard, which is intended for wired connection with any legacy device outputting an analogue audio-video signal, typically a Digital Video Disc player and the like, and thus comprises a first composite video (‘CVBS’) RCA socket 444₁, a second stereo RCA socket 444₂ for the right audio channel and a third stereo RCA socket 444₃ for the left audio channel.

The third audio-video input interface 446 is another analogue interface conforming to the coaxial radiofrequency standard, which is intended for wired connection with a remote antenna apt to intercept broadcast radio waves, and thus comprises a Type-N or Type-F female socket 446.

The rear side 440 of the device 101 also comprises at least one audio-video output interface 448, being in this embodiment a second HDCP-HDMI socket digital which is intended for connection with the HDCP-HDMI socket of the television set 102. The rear side 440 of the device 101 further comprises a wired network interface 450 for a wired connection to the adjacent LAN router 109, and thus comprises an 8-position 8-contact (8P8C) socket (‘RJ45’) 450, as well as at least one USB interface 452 and, finally, a cylindrical DC socket 454 for connection to a conventional Power Supply unit including a transformer.

The remote control device 430 is supplied with the display communication device 101 and is preferably of the type which is capable of learning one or more control functions of other remote control handsets, so that an on/off button 431 of the remote control device 430 may advantageously be used to turn on and off the TV 102 as well as the device 101, and volume and channel buttons 432 be respectively used to alter the audio volume of the TV 102 and change the input audio-video selection of the device 101, e.g. switch between DVB channels or between audio-video sources respectively connected to the input sockets 442, 444, 452. Corresponding control commands are sent to the TV 102 and the interactive device 101 conventionally via an infrared emitter 433 integral to the remote control device 430.

The remote control device 430 further comprises a plurality of colour-coded, variable-function buttons, in the example a red button 435, a green button 436 and a blue button 437 which are grouped and located distal the bloc of conventional TV-operating function buttons 431, 432, and a navigational user input interface 438, in the example a directional pad 438 with up, down, left and right arrows, which is located intermediate the bloc of conventional TV-operating function buttons 431, 432 and the variable-function buttons 435, 436, 437.

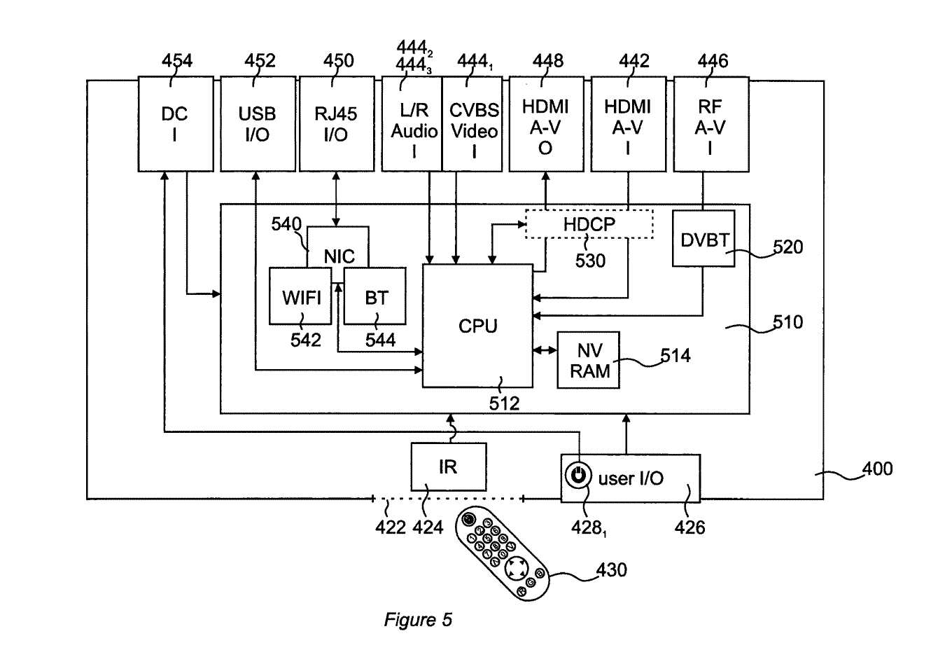

An embodiment of hardware architecture for the display communication device 101 is shown in FIG. 5 in further detail, by way of non-limitative example and limited to relevant components for the sake of not obscuring the present description unnecessarily. Within the device enclosure 400, each of the infrared receiver 424 and the user control panel 426 of the front face 420 and each connector 442, 444_{N}, 446, 448, 450 and 452 of the rear face 440 is interfaced with a motherboard 510 implementing an integrated chipset, for instance manufactured under the reference BCM7242 by the Broadcom Corporation of Irvine, Calif., USA. The chipset is further interfaced with the DC input 454 by way of a power supply, and the DC input socket 454 is thus also connected with the on/off button 428₁ of the user control panel 426.

The chipset 510 comprises a single-core or multi-core central data processing unit (CPU) 512 in data connection with a non-volatile random access memory 514 which stores a set of instructions for configuring the device 101 with the functionality as described herein when processed by the CPU 512 at runtime. The chipset 510 thus also includes a DVB-T2 tuning module 520 for processing waveform signals input to the RF connector 446 into digital broadcast signals, and a HDCP module 530 operably connected to each of the input and output HDMI sockets 442, 448 for ensuring operational compliance of the device 101 with media protection encoded in a source digital signal, for instance from a BluRay player connected to the input HDMI connector 442.

The chipset 510 further comprises a network interfacing module 540 operably interfaced with each of the network RJ45 socket 450, a wireless local area network (WLAN) module 542 emulating the network connectivity of the network RJ45 socket 450 over the air, and a Bluetooth module 544 replicating the wireless functionality of the WLAN module 542 under a different networking protocol, for instance emulating, when paired with a nearby wireless device 105 suitably configured with a relevant application, the functionality of the remote infrared receiver 424 and remote control 430.

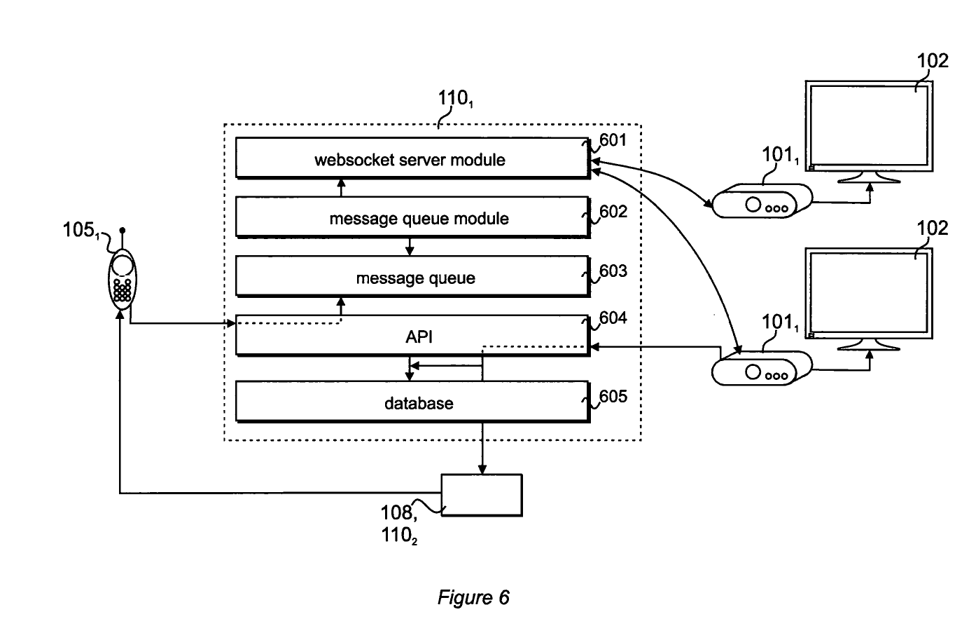

In the example, any user operating a mobile terminal 105_{N} or another type of network-connected data processing terminal having equivalent functionality may access a website portal distributed by the server 110 for locally authoring and configuring a message containing at least an alphanumerical sequence representative of the message addressed to one or more display communication device 101_{N}. FIG. 6 provides a functional representation of the message flow in the system of FIG. 1, between each of a mobile terminal, the server 110 and interactive display communication devices 101₁, 101₂.

In the example shown in FIG. 6, each display communication device 101₁, 101₂ is operated by a respective user residing in a care home, wherein the two display communication devices 101₁, 101₂ are grouped at the server 110 according to this common geographical residence characteristic. The mobile terminal 105 is a care home equipment operated by care home staff, whereby messages originating from the mobile terminal 105 may be sent to either display communication device 101₁, 101₂, for instance when the message content is personal and/or specific to a respective user, or to both devices jointly, for instance when the message content is about a care home event or procedure applicable to both users.

The server 101 is configured to implement, at runtime, a plurality of functional data processing modules, including firstly a websocket module 601 which maintains a bilateral connection between itself and each display communication device 101_{N}, for sending outgoing data packets thereto across the WAN 111 in real time, over a private channel that is encrypted with SSL.

A message queue module 602 fetches messages that are buffered in a queue of outgoing messages 603 and serializes them in a suitable wire format before passing the resulting data blob to the websocket module 601 for delivery.

A server-side API 604 interfaces the server with incoming data packets from remote terminals 105_{N}, 101_{N} received across the WAN 111, wherein such incoming data packets include both messages addressed by remote terminals 105_{N} to display communication devices 101_{N} and responses to the messages received from the display communication devices 101_{N}. The API writes the incoming message data to a database 605 and passes the incoming messages to the message queue 603 in real-time. The API also writes the incoming response data to the database 605 and calls registered web hooks with each response for forwarding the response data to the respective originating remote terminal 105_{N} via a relevant WAN pathway 108, 110₂.

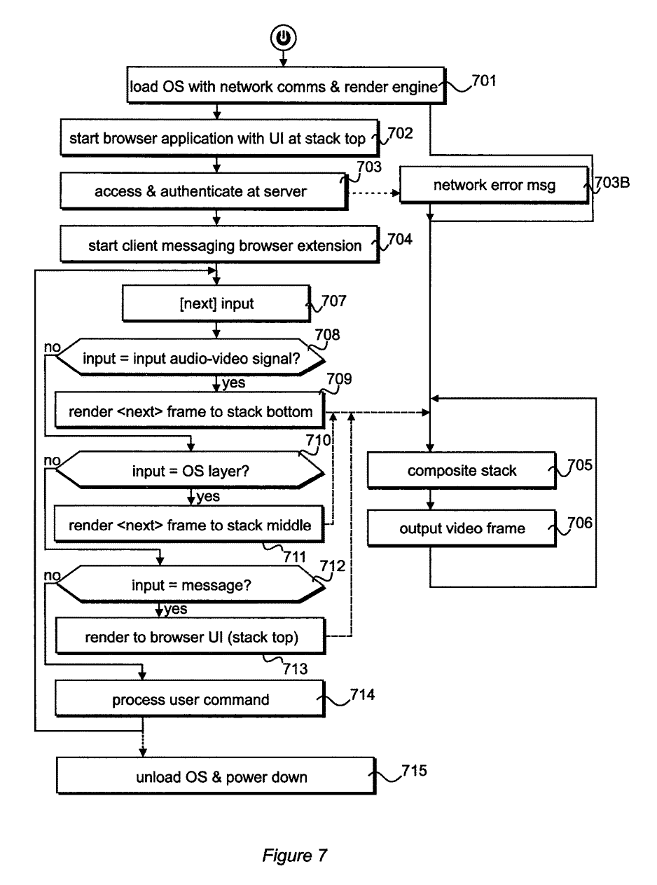

FIG. 7 accordingly details data processing steps of an embodiment of the method of the invention performed by the interactive messaging device 101 of FIGS. 1, 4 and 5 to implement the message flow of FIG. 6.

Each time a display communication device 101_{N} is powered, it loads an operating system or ‘firmware’ at step 701, including subroutines required to provide networking functionality through the network interfaces 540, 542, 544 and to output a digital audio-video signal 448 in the form of a continuous sequence of composited display frames, wherein each such display frame is composited from a stack of display layers, having the input video signal assigned to the bottom display layer in the stack when processed by the CPU 512.

At step 702, a browser application, is started by the firmware, and the browser user interface, having a layer resolution corresponding substantially to the entire area of the display frame output by the device 101, is assigned to the top display layer of the stack, being a clear or transparent user interface in its default setting.

The display communication device 101_{N} comprises a client messaging application which is used to deliver a modal dialog on the TV screen 102 of a user by overlaying either an internal DVB-T tuner signal 446, HDMI input signal 442 or CVBS input signal 444 with messages in real-time.

At step 703, a startup subroutine checks whether a connection to the WAN 111 is currently available. If a network connection is available, the subroutine redirects the browser application of the firmware to a Uniform Resource Locator (URL) address of the server 110 and loads the client messaging application at step 704, wherein the client messaging application is embodied as an extension of the browser application.

Alternatively, if a network connection is not present, a device dialog message is output (703B) to the top layer of the display stack with relevant support contact information and the subroutine then periodically checks for network availability. When network connectivity is eventually established and step 703 performed, the startup subroutine ends and redirects to the loaded client messaging application per step 704.

Pursuant to the loading of the display output subroutine of step 701, whilst steps 702 to 704 are performed, and regardless of whether the user of the device 101 interacts therewith in real-time with either conventional control commands for instance to change the source signal, broadcast channel or sound volume level, or interactive telecommunication steps all as described hereafter, the device continually composites the contents of the display layer stack at step 705 and outputs composited display frames as video frames at step 706.

Thus, the video feed input to the device is output to the TV set 102 as a result of the video processing loop 705, 706 and the device continually polls for a next input at step 707 in parallel. When the next input is identified as an input audio-video signal at step 708, the next frame thereof is processed with the firmware and rendered to the bottom display layer of the stack at step 709, to then be composited at step 705 and output at step 706.

Alternatively, when the next input is identified as a conventional control command associated with conventional functions of the firmware at step 710, for instance to call up an Electronic Program Guide for selecting a DVB channel, the system user interface is processed with the firmware and rendered to a display layer of the stack located intermediate the bottom video layer and the top browser layer at step 711, to then be composited at step 705 and output at step 706.

Alternatively still, when the next input is identified as a message received from the remote websocket module 601 at step 712, the message is processed with the client messaging application and rendered to the browser user interface at the top browser layer at step 713, to then be composited at step 705 and output at step 706, thus overlaying each of the bottom video layer and, if any is present, the intermediate menu layer.

If the input is none of the three types according to steps 708, 710, 712, it is identified as a message response input and, at step 714, passed to the client messaging application rather than to the firmware, and processed therewith at step 714. Control returns to step 707 at which a next input video frame may be processed according to steps 708, 709, 705, 706; a next conventional control command may be processed according to steps 710, 711, 705, 706; a new message may be processed according to steps 712, 713, 705, 706; and a response input to a displayed message may be processed according to step 714, and so on and so forth.

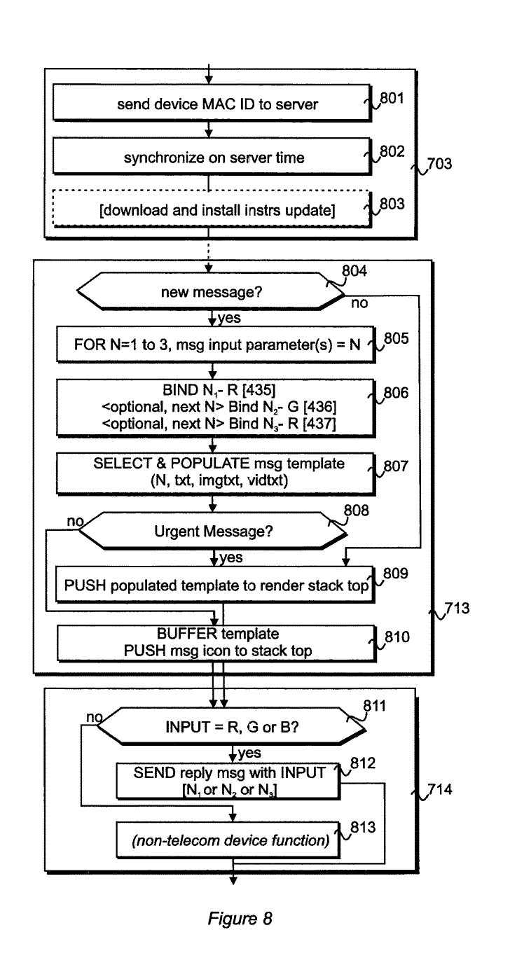

The start-up step 703, message processing step 713 and response data processing step 714 are described in further detail hereafter, with reference to FIG. 8.

With reference to the start-up step 703 firstly, at step 801, the startup subroutine authenticates itself against the API 604 using the device's unique MAC address. Using the device's unique ID within the network environment of FIG. 1, the web socket 601 is able to route any and all respective messages to the device. At step 802, the internal clock of the device 101 is synchronized with the time maintained at the remote server 110, in order to facilitate maintenance communication between the server 110 and all devices 101_{N} in the environment, regardless of the respective time zones in which some may be relative to others. Upon successful authentication, the startup subroutine reports the current versions of the firmware and the client messaging application to the API 604. If a newer version of the firmware is available, the API 604 schedules its upload to the device 101 on the message queue 603 with a system message notifying the user about the available update and requesting that the user acknowledges or agrees with the updating task. An update is subsequently performed at step 803.

With reference to the message processing step 713 next, a question is asked at step 804, as to whether the message is a newly-received message. When the question is answered positively, the client messaging application firstly enumerates the one or more input parameters encoded in the received message at step 805 and which, in the example and with reference to the messaging-related inputs 435, 436, 437 of the remote control 430, number a maximum of 3.

At step 806, the client messaging application next binds each of the one or more input parameters encoded in the received message with a respective input 435, 436, 437 of the remote control 430. This ability to allow the running application to bind to a given keyset is achieved by the firmware injecting a javascript object into the browser to act as a bridge between itself and a running application.

At step 807, the client messaging application next selects a message display template according to the message data contents, wherein different types of message templates are provided respectively according to whether the message contains alphanumerical data only, or also includes image data or video data, and also according to how many input parameters have been enumerated. The selected template is accordingly populated with the message data.

At step 808, a further question is asked, as to whether the received message is an urgent message, for instance designated as such with a relevant flag bit by the server 110 as a result of a corresponding selection by the message sender with their mobile terminal 105. When the question is answered positively, then the client messaging application pushes the populated template to the display stack at step 809, whereby the complete message is immediately overlaid on the video signal displayed by the TV set 102 as a result of the compositing and output of steps 705, 706. Alternatively, the message is not urgent and the client messaging application instead buffers the populated template and pushes a message icon to the display stack at step 810, for instance a graphical representation of the remote control's red input button 435, which is immediately overlaid on the video signal displayed by the TV set 102 as a result of the compositing and output of steps 705, 706.

With reference to the message response processing step 714 next, and pursuant to the binding of step 806 according the message input parameters preceding the output of the message to the display stack, the user input into the remote control 430 captured by the infrared received 242 is submitted to a determination at step 811, as to whether it constitutes a conventional control command, for instance to change the source signal, broadcast channel or sound volume level, or whether it corresponds to any one of the one or more bound interaction keys 435, 436, 437.

If the user input is conventional, the determination of step 811 is negative and the input selection is kept by the firmware at step 813, and eventually processed at steps 710, 711 on the next iteration of the processing loop.

Alternatively, if the user input corresponds to a bound interaction key, the determination of step 811 is positive and the input selection is passed by the firmware to the client messaging application, which selects the input parameter respectively bound to the user input, encodes it in a reply network message, and sends it to the API 604 at step 812. Pursuant to the principles described herein in connection with FIG. 6 and elsewhere, the user of the mobile terminal 105 at which the message was originated, then relayed to the target recipient device 101 by the server 110, receives the reply network message, and optionally also a copy of the original message by way of reference.

At its simplest, the reply network message may for instance be a confirmation that the message has been displayed, with the original message having a single ‘acknowledgement’ input parameter bound by the client messaging application to the red key 435, which the user of the target recipient device 101 is required to press in order to remove the displayed message from the top display layer.

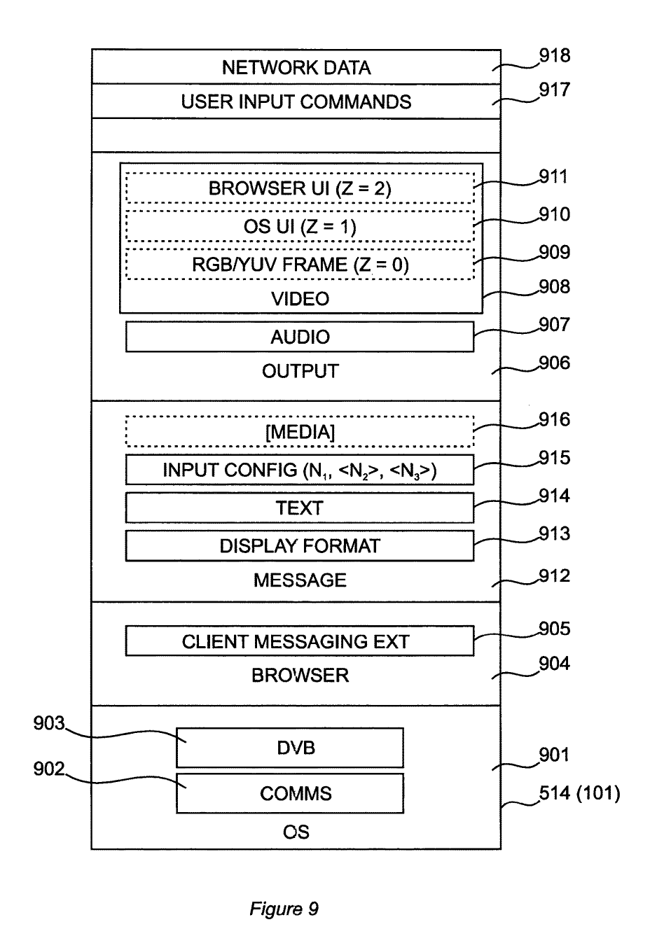

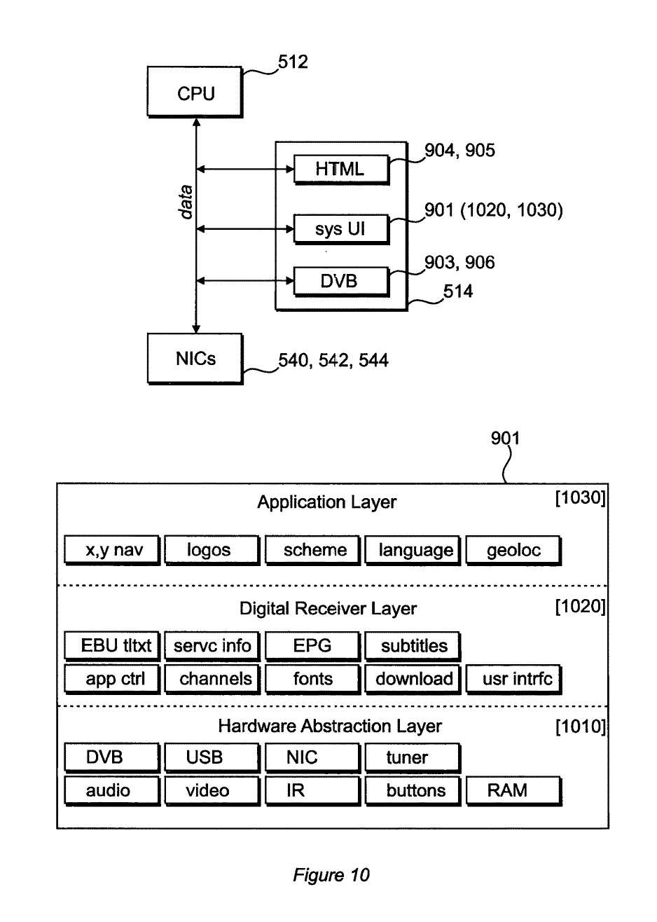

FIGS. 9 and 10 are respective diagrams of the contents of the memory means of the or each device 101_{N} shown in FIGS. 1, 4 and 5 at runtime, when performing the method steps of FIGS. 7 and 8.

With reference to FIG. 9 firstly, the contents of the NVRAM 514 are shown by way of example, and firstly include the firmware 901 with its network communication subroutines 902 and its video data processing subroutines 903 as described with reference to steps 701, 702. The browser, in the example a version of Webkit, is shown at 904 and the client messaging application of steps 703, 713, 714 is shown as an extension of the browser at 905.

Audio-video data continually output by the device 101 via the HDMI output socket 448 is shown generally at 906 and includes both an audio data stream 907 and a video data stream 908 of frames, each composited from the stack of display layers comprising at least the bottom RGB or YUV layer 909 incorporating the processed input video data stream, the intermediate menu layer 910 incorporating one or more graphical user interfaces associated with conventional functions of the device 101 as described hereafter, and the top browser messaging layer 911.

Message data 912 corresponding to a message received and processed at steps 712, 713 by the client messaging application 905 includes the message display template or format 913 selected at step 807, the alphanumerical content 914 of the received message, the one or more input parameters 915 encoded in the received message for binding at step 806 and, optionally, any additional image or video data content 916 of the received message.

User commands input to the remote control 430, transmitted and captured by the infrared receiver 424 are also shown at 917, for processing according to steps 710, 711, 714. Lastly network data is shown generally at 918 and comprises both incoming message data packets to be processed according to steps 712, 713, outgoing response data packets communicated by the client messaging application 905 to the remote server 101 pursuant to step 812, and optionally firmware and/or client messaging application updates pursuant to step 803, besides further incoming and/or outgoing data packets that are outside the scope of the present description.

The physical and bilateral data flow between the device CPU 512 and the various chipset components interfaces 540, 542, 544 via the NVRAM 514 is shown in FIG. 10 with reference to the data structures shown described with reference to FIG. 9. The firmware 901 firstly comprises a hardware abstraction layer 1010 which provides the logical interface between the physical form of the data input and output via the physical components of the device, such as the USB socket 452, the network socket 450, the DVBT module 520 in combination with the RF socket 446 and more, and the binary form of the data processed by the firmware subroutines such the device menu, the browser 904 and the client messaging application 905.

The hardware abstraction layer 1010 bridges these physical inputs and outputs with a digital receiver layer 1020 of the firmware, at which the data input to the CPU 512 by the DVBT module 520 is processed and output as for instance the bottom video layer data 909, the DVB EPG and its data content, and more. The firmware 901 also comprises an application layer 1030 for data formatting protocols and methods associated with user interfaces of the firmware 901, for instance EPG navigation input data, user interface display schemes, user interface language in combination with data representative of the geographical location of the device 101.

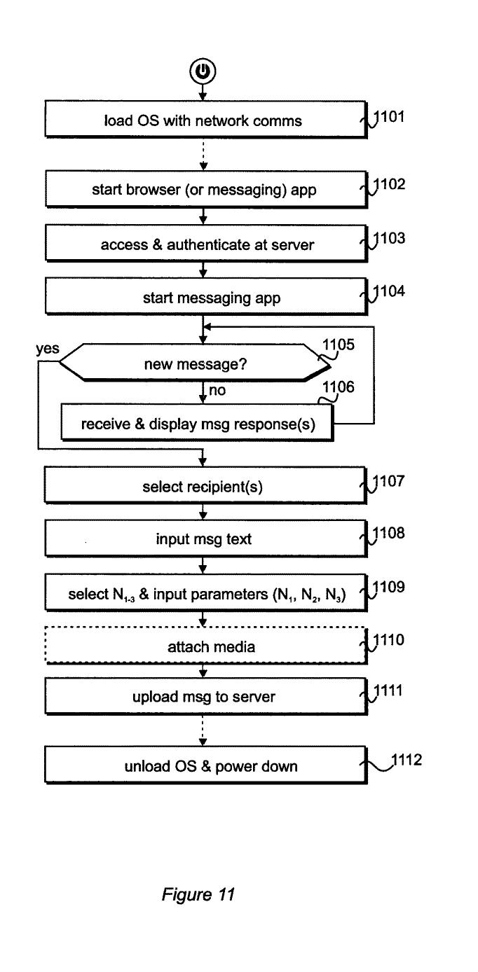

FIG. 11 details data processing steps of an embodiment of the method of the invention performed by one or more of the mobile data processing and communication terminals 105_{N} of FIGS. 1 and 2 at runtime, in parallel with the steps 701 to 715 performed by each device 101_{N}.

Each time a mobile communication handset 105_{N} is powered, it loads an operating system or ‘firmware’ at step 1101, including subroutines required to provide telecommunication and networking functionality through the modem 203. Further processing steps may be performed by the mobile terminal as part of its starting-up procedure, and/or may be performed by its user thereafter for any length of time, which are outside the scope of the present description. When the user eventually wants to send a message to one or more remote interactive display communication devices 101_{N}, or verify the status of one or more previously-sent such messages, then at step 1102, depending on the embodiment of the system, either a browser application of the mobile terminal is started for accessing a URL of the server 110, or the loading procedure of a local messaging application previously downloaded from the server 110 is started. In either case, the user of the mobile terminal 105 is required to authenticate access at the server 103 at step 1103, to verify that the user is registered and suitably authorized for sending a message to any one or more interactive display communication devices 101_{N}. When access to the server 110 is validated, again depending on the embodiment, then respectively either a messaging interface is served by the server 110 to the mobile terminal over the WAN 111, or the local messaging application is started at step 1104.

At step 1105, a question is asked, as to whether a new message selection has been received. If the question is answered negatively, then at step 1106 the server 110 communicates any outstanding message response not previously sent to the terminal 105, for instance following a prolonged interruption of the network connection between the mobile handset 105 and the server 110. So long as the question of step 1105 is answered negatively, control loops and effectively awaits receipt of any outstanding message response from the server API 604, which communicates any such responses in real-time as previously described, for displaying to the sending user at step 1106.

When the question is answered positively, then at step 1107 a new message is instantiated and the sending user first identifies one or more recipients for the message, in the example all the care home residents equipped with an interactive display communication device 101. At step 1108, the sending user inputs alphabetical or alphanumerical data 914 as the body of the message. At step 1109, the sending user selects one or more input parameters 915 and again inputs alphabetical or alphanumerical data for each such selection, each as a respective reply possibility provided to the message recipients. In the example, the user wishes the care home residents to select respective medical appointment dates of their choice.

Accordingly, at step 1108, the user inputs the text string “Medical visits will take place next week, please select your preferred date” 914 and, at step 1109, the user inputs a first input parameter N₁ as “Monday 14:00” 915 and a second input parameter N₂ as “Tuesday 10:00” 915. At a further optional step 1110, the user may attach media data 916, for instance an image, photo or movie representative of, or logically associated with, a medical visit. When the message is fully composed, it is then uploaded to the server API 604 at step 1111 for real-time forwarding to the addressed interactive display communication devices 101_{N} by the websocket module 601.

Further interaction may take place, until the mobile handset is eventually switched off at a step 1112. Until that time, whilst the mobile terminal remains powered and so long as the browser or messaging app is maintained in a runtime state, control returns to the question of step 1105, and the respective replies from the recipients input according to step 714 are eventually displayed to the sending user at respective iterations of step 1106.

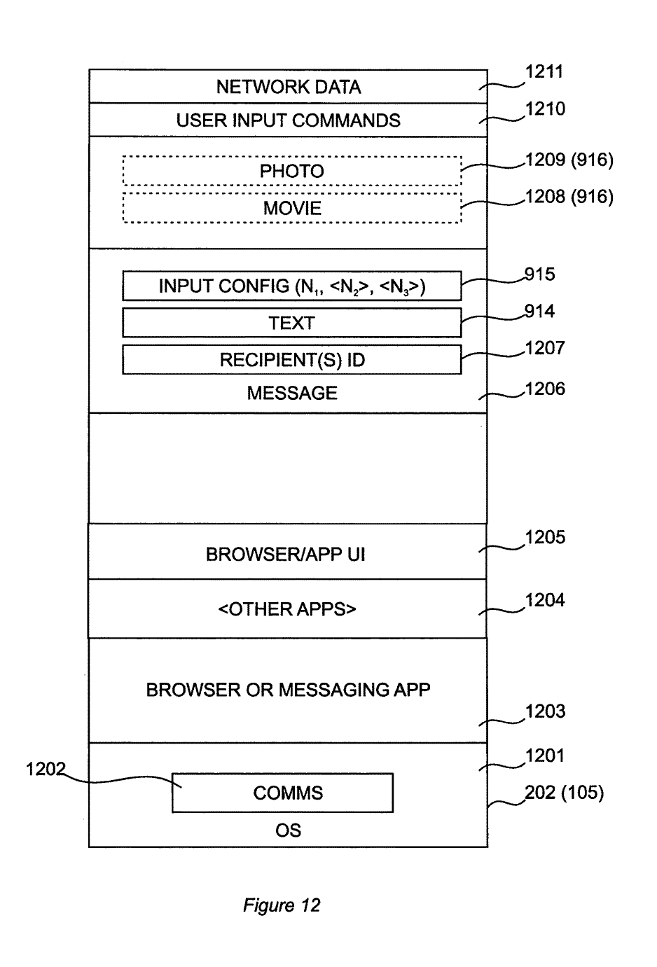

FIG. 12 is a logical diagram of the contents of the memory means 202 of an interlocutor mobile terminal 105 as shown in FIGS. 1 and 2, when performing the method steps of FIG. 11 at runtime. It will be readily understood by the skilled person that the foregoing is applicable to the alternative memory means 309 of a non-mobile or less-mobile data processing terminal 110 having a hardware configuration substantially similar to that of the server 110 shown in FIG. 3, when performing substantially the same steps 1102 to 1111 at runtime.

An operating system is firstly shown at 1201 which, depending on the handset manufacturer, may be iOS 7™ developed and distributed by Apple Inc. or Android™ developed and distributed by Google Inc. A subset of instructions 1202 of the OS 1101 is dedicated to communication processing, in particular data communications with remote terminals 101_{N}, 110_{N} within the network environment of FIG. 1.

A browser application is shown at 1203, which may instead correspond to a messaging app in an alternative embodiment, either of which configures the mobile handset 105 to process and display new message data and response message data as described hereinbefore. The memory 202 may comprise one or more further applications being processed in parallel with the browser 1203 at runtime, that is or are unrelated to the present invention and generally shown at 1204.

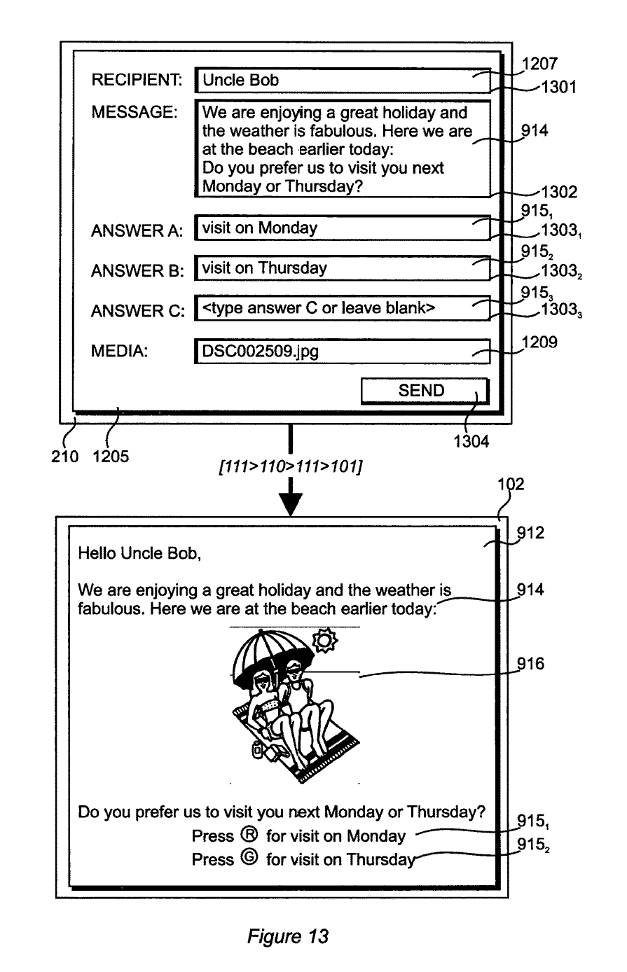

Browser or app application data firstly comprises a graphical user interface 1205 output to the display 210 and into which the new message data and response message data is rendered, an example of which is illustrated in FIG. 13. The messaging data itself is generally shown at 1206 and comprises the message recipient identifier(s) 1207 selected at step 1107, the message body 914 of step 1108 and the one or more message input parameters 915 of step 1109. The memory 202 may also comprises media data, for instance a movie 1208 or a photograph 1209 captured with the CCD 208 and which may be attached 916 to a message.

User input commands are shown at 1210, and comprise selections of the sending user on the touchscreen VDU 210 translated into screen coordinates and processed by the firmware 1201 into context- or application-relevant input commands, and any comparable input, for instance alphanumerical data input via a keyboard device 303 connected to the mobile handset via USB 212 or wirelessly via Bluetooth. Lastly network data is shown generally at 1211 and comprises both incoming response data packets to be processed according to steps 1105, 1106 and outgoing message data packets communicated to the remote server 110 pursuant to step 1111, besides further incoming and/or outgoing data packets that are outside the scope of the present description.

With reference to FIG. 13, a message 1206 is shown in a user interface 1205 displayed on the VDU 210 of a mobile terminal 105 during its authoring according to the steps of FIG. 11. The recipient 1207 is input in a first dialog box 1301, then the message body 914 is input in a second, larger dialog box 1302. In the example, the user of the mobile terminal 105 is holidaying and sending the message from a beach location to keep the recipient user of the interactive display communication device 101 informed about her activities.

The holidaying user intends to visit the message recipient upon her return from holiday, and can do so either on a Monday or a Thursday. Pursuant to steps 1108, 1109 the mobile terminal user thus selects a first input parameter 915₁ by inputting a narrative “visit on Monday” in the first input parameter dialog box 1303₁, then thus selects a second input parameter 915₂ by inputting a distinct narrative “visit on Thursday” in the second input parameter dialog box 1303₂. The third dialog boxes 1303₃ is left empty and thus no input parameter will be associated with the third button 437 of the remote control 430. The holidaying user lastly chooses to attach a digital photograph 1209 captured with the mobile handset camera 208 to the message at step 1110, then selects a send button 1304 when the message is fully composed.

With reference to FIG. 6, the message is uploaded to the remote server 110 across the WAN 111, then forwarded to the target device 101 by the websocket 601 across the WAN, whereby it is then processed with the client messaging application such that all of the message body 914, the photograph 916 and the first and second input parameters 915₁, 915₂ are populating a template 912 rendered to the browser user interface at the top browser layer at step 713, to then be composited at step 705 and output at step 706 to the TV set 102. Each of the first and the second input parameter 915₁, 915₂ is associated with a respective input 435, 436 of the remote control device 430 for intuitive interaction with the device so as to return a choice of either “Monday” with the red input button 435 or “Thursday” with the green input button 436 for the planned visit. This reply will eventually reach the sending user pursuant to steps 1105, 1106.

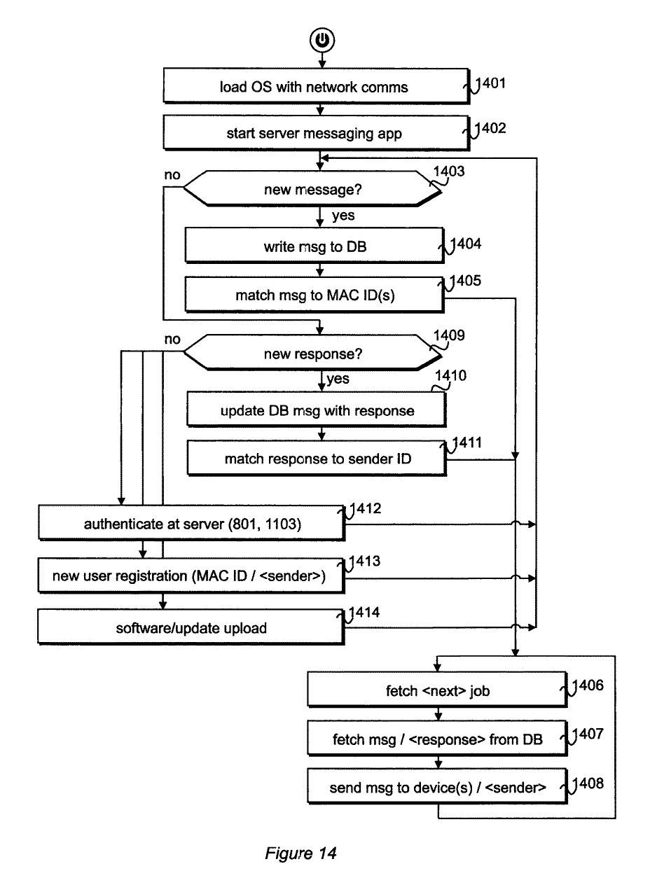

FIG. 14 details data processing steps performed by the server 110 of FIGS. 1 and 3, in parallel with the steps 701 to 714 and 801 to 812 performed by one or more remote interactive devices 101_{N} and the steps 1102 to 1111 performed by one or more mobile terminals 105_{N}.

When the server 110₁ is first powered, it loads an operating system or ‘firmware’ at step 1401, including subroutines required to provide networking functionality through the NIC 311. A server messaging application is next started at step 1402, which implements the data processing functionality first described with reference to FIG. 6. Accordingly, at step 1403 a first question is asked as to whether the server has received a new message 1207 from a remote sender terminal 105_{N} or 110₂.

When a message is received at the server 110₁ pursuant to step 1111, the question 1403 is answered positively and the server messaging application firstly writes the received message data structure into the database 605 at step 1404, then at step 1405 matches the one or more recipient ID encoded in the message to the respective MAC identifiers of the one or more devices 101_{N} associated with each recipient, previously updated pursuant to step 801.

The outcome of the matching operation 1405 triggers the queuing of a corresponding message communication job in the message queue 603, which the queue module 602 subsequently processes at step 1406. At step 1407, the queue module 602 fetches the stored message corresponding to the next queued job from the database and, at step 1408, passes the message to the websocket 601 for communicating to the one or more target device(s) 101_{N}. Steps 1406 to 1408 constitute a looping subroutine processed substantially in parallel with the remaining steps described herein.

When the question 1403 is answered negatively, a next question is asked at step 1409, as to whether the server has received a new response 917 from a remote interactive display communication device 101_{N}.

When a response is received at the server 110₁ pursuant to step 714, the question 1409 is answered positively and the server messaging application firstly updates the message data structure previously stored in the database 605 at step 1404 with the received response at step 1410, then at step 1411 matches the message data structure with the original sending terminal 105_{N}, for instance via webhooks encoded in the original message 1207.

The outcome of the matching operation 1411 triggers the queuing of a corresponding response message communication job in the message queue 603, which the queue module 602 subsequently again processes at step 1406. At step 1407, the queue module 602 again fetches the stored message corresponding to the next queued job from the database, this time including the stored response data and, at step 1408, communicates the message and its response to mobile terminal 105_{N}.

When the question 1409 is answered negatively, the next step may consist of any one of several data processing tasks not associated with the core messaging function of the application, and a next step 1412 relates to the authenticating procedure of either an interactive display communication device 101 pursuant to step 703 or a user mobile terminal 105 pursuant to step 1103.

A further step 1413 relates to the initial registration of either an interactive display communication device 101 with the server messaging application and the database, of the authentication parameters and data for a new user of a mobile terminal 105, in either instance after a purchase of a new device 101.

A further step 1414 relates to the serving of either a firmware update to one or more devices 101 pursuant to step 803, or of a website interface to a requesting mobile terminal 105 pursuant to the web-served embodiment discussed in relation to step 1102 to 1104.

Further processing steps may be performed by the mobile terminal as part of its starting-up procedure, and/or may be performed by its user thereafter for any length of time, which are outside the scope of the present description.

With reference to step 1413 and the registration of remote interactive devices 101_{N} and message-sending users, in an embodiment of the invention, the remote interactive devices 101_{N} may be grouped according to a variety of criteria, and users of sending terminal 105_{N} may likewise be registered for sending messages to groups of remote interactive devices 101_{N} according to a hierarchy.

Using the example of a care home environment, the database and the server messaging application may be so configured to embody customers, wherein a customer is the care home organization which registers at the server 110 for using the messaging service; and sites, wherein a customer may be associated with multiple sites, and wherein a site is a container for a group of residents each having the use of an interactive device 101_{N}, who may or may not be geographically related.

Further, the database and the server messaging application may be so configured to implement hierarchical user account types, consisting of staff user accounts with complete user access and granted all permissions; resident user accounts for users of interactive devices 101_{N} as the intended recipient of the messages, and who cannot generate messages or can only send pre-configured messages; supporter user accounts for users associated to residents, in the example the users of mobile handsets 105_{N}, and who must be approved by a resident to be able to send messages and receive responses, but who cannot be associated with one or more residents so as to avoid interest-conflicting use of the system; customer administrator user accounts, each being a role tied to a specific customer, which is enabled across multiple sites but only within a same organization, and which send messages, add sites and users and monitor messaging activity; and care provider user accounts, each being a role tied to multiple organizations, and which can send messages to residents across multiple sites and organizations.

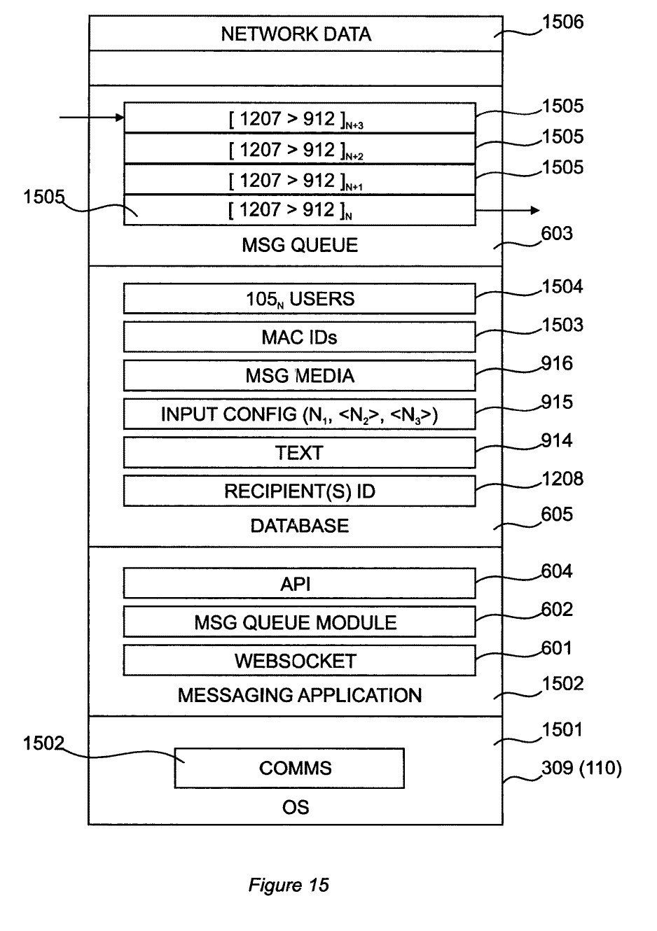

FIG. 15 is a logical diagram of the contents of the memory means of the server 110 shown in FIGS. 1 and 3, when performing the method steps of FIG. 13 in the context illustrated by FIG. 6.

An operating system is shown at 1501 which, if the server 110₁ is a desktop computer, is for instance Windows Server 2012 R2™ distributed by the Microsoft Corporation. The OS 1501 includes communication subroutines 1502 to configure the terminal 110 for bilateral network communication in the network environment of FIG. 1 via the NIC 311, then the router 109.

A server messaging application is shown at 1502, which configures the terminal 110₁ to perform at least processing steps 1401 to 13XX as described hereinbefore, and which is interfaced with the OS 1501 and network communication subroutines 1502 thereof via one or more suitable Application Programmer Interfaces. Accordingly, data processing subroutines or modules of the server messaging application include the websocket module 601, the message queue management module 602 and the server-side messaging API 604. The

Server messaging application data firstly comprises the database 605 into which messages 1207 received from senders 105_{N} are written by the API 604 and thus stores, for each such message 1207, message recipient ID data 1208, message body data 914, message input parameters 915, any message media 916 and webhooks for routing the eventual response data 917 to the original sender. The database also stores the respective MAC identifier of each interactive display communication device 101 at 1503, and authenticating data 1504 for validating users' respective access to the server 110 at step 1103.

The message queue 603 is next shown in the form of a First-In-First-Out (FIFO) buffer comprising a plurality of sequential messaging jobs 1505, wherein the queue is updated and the jobs therein processed in real-time, thus including ordered requests to forward new messages 1207 to one or more recipient devices 101.

Lastly network data is shown generally at 1506 and comprises, at any given time, any of incoming message data packets from remote terminals 105N, incoming message response data packets from remote devices 101N, outgoing message data packets to remote terminals 105N, outgoing response message data packets to remote terminals 105N, outgoing updating data packets pursuant to step 803, incoming authenticating data pursuant to step 1103, and outgoing webpage or application content data pursuant to step 1104, besides further incoming and/or outgoing data packets that are outside the scope of the present description.

The present invention thus provides an alternative telecommunication method and a corresponding system, both based on an interactive display communication device 101, for users unskilled in, and/or not equipped with, ubiquitous telecommunication methods involving mobile telephones 105 or computers 110, wherein messages 912 personalised by respective senders are communicated to display equipment 102 and automatically overlaid on a displayed broadcast or local source video signal 909 when received, and reply interaction simply requires the recipient to be familiar with conventional operation of their display equipment 102.

Many implementing variations may be devised by the skilled person in dependence upon requirements of increased functionality, simplicity of implementation, availability of data processing and network bandwidth, scalability and more.

The embodiments in the invention described with reference to the drawings comprise a computer apparatus and processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1.-36. (canceled)

37. A method of communicating with an interactive display communication device connected to a network, comprising the steps of
encoding at least one input configuration parameter in a message remotely from the device and communicating message data to the device,
processing a client messaging application at the device for displaying received messages in a user interface,
processing output video data at the device as a plurality of composited display layers including at least top and bottom layers,
assigning video data input to the device to the bottom layer,
assigning the user interface to the top layer,
and when message data is received at the device,
processing the message data with the client messaging application,
configuring a remote user input associated with the device for interaction with the client messaging application according to the or each input configuration parameter, and
outputting the message to the user interface.

38. The method according to claim 37, wherein the client messaging application comprises a browser configured with a client messaging extension, and wherein the step of assigning a user interface further comprises assigning a transparent user interface of the browser to the top layer.

39. The method according to claim 38, wherein the step of outputting further comprises substituting a portion of the transparent user interface with the message.

40. The method according to claim 37, wherein the step of encoding further comprises encoding a plurality of input configuration parameters in the message, wherein each input configuration parameter is respectively assigned to an input command of the remote user input.

41. The method according to claim 37, wherein the steps of encoding and communicating are performed at a remote server over the network.

42. The method according to claim 41, comprising the further step of inputting message data and selecting the or each input configuration parameter with a networked terminal remote from the server and the interactive display communication device.

43. The method according to claim 42, comprising the further step of associating media data with the input message data, wherein the media data is at least one selected from the group comprising audio data, video data, image data and audio-video data.

43. The method according to claim 43, wherein the step of associating further comprises recording the media data locally with the networked terminal remote from the server and the interactive display communication device.

44. The method according to claim 37, comprising the further steps of reading at least one input command from the remote user input and matching the or each input command to a respective input configuration parameter at the device.

45. The method according to claim 44, comprising the further steps of processing reply message data according to the or each matched input configuration parameter and communicating the reply message data to a remote recipient.

46. A display communication system comprising
at least one interactive display communication device connected to a network and adapted to process a client messaging application for displaying one or more received message in a user interface and to composite the user interface on an input video stream, wherein the device is provided with remote user input for interacting with the device in real time, and
a first remote data processing terminal connected to the network,
wherein the first remote terminal processes a server messaging application communicating message data across the network to the client messaging application processed by the or each interactive display communication device, and
wherein the remote user input is configurable by the server messaging application for interaction with the client messaging application according to at least one configuration parameter encoded in each message.

47. The system according to claim 46, wherein the client messaging application comprises a browser configured with a client messaging extension, and wherein the user interface is a transparent user interface of the browser.

48. The system according to claim 46, wherein the or each interactive display communication device comprises one selected from the group comprising a television set, a set top box, a physical media player, a digital media player, a streaming media player, a videogames console.

49. The system according to claim 46, wherein the remote user input comprises at least one selected from the group comprising an IR remote control device, an RF remote control device, a mobile telephone handset.

50. The system according to claim 46, further comprising at least a second remote data processing terminal connected to the network, adapted to input message data and to select the or each input configuration parameter remotely from the first remote data processing terminal and from the or each interactive display communication device.

51. The system according to claim 46, wherein the or each second remote data processing terminal is selected from the group comprising mobile telephone handsets, mobile computers, tablet computers, desktop computers.

52. The system according to claim 46, wherein the first remote data processing terminal is further configured to communicate a message to a plurality of interactive display communication devices grouped according to at least one predetermined criteria.

53. The system according to claim 46, wherein the or each interactive display communication device is uniquely identified to the first remote data processing terminal by its Media Access Control (‘MAC’) address.

54. The system according to claim 46, wherein the or each interactive display communication device is an audio-video pass-through device having connectivity for connection to legacy audio-video equipment.

55. An interactive display communication device comprising
audio and video data input means
audio and video data output means
networking means
all operably interfaced with data processing means configured to
process a client messaging application for displaying each received message in a user interface,
process output video data as a plurality of composited display layers including at least top and bottom layers,
assign input video data to the bottom layer,
assign the user interface to the top layer,
wherein the device is provided with remote user input means for interacting with the device in real time and, when message data is received via the networking means, the data processing means is further configured to
process the message data with the client messaging application,
configure the remote user input means for interaction with the client messaging application according to at least one input configuration parameter encoded in the message data, and
output the message to the user interface.
